(19) United States
(12) Patent Application Publication
(10) Pub. No.: US 2009/0262279 A1
(43) Pub. Date: Oct. 22, 2009

(54) INVERTER FOR LIGHT SOURCE DEVICE, LIGHT SOURCE DEVICE, DISPLAY DEVICE AND LIQUID CRYSTAL DISPLAY DEVICE

(75) Inventor: Hideki Koh, Mie (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/090,674

(22) PCT Filed: Aug. 17, 2006
(86) PCT No.: PCT/JP2006/316163

§ 371 Date: Apr. 18, 2008

(30) Foreign Application Priority Data
Nov. 28, 2005 (JP) 2005-341593

(51) Int. Cl. G02F 1/1335; H05B 37/02

(52) U.S. Cl. 349/61; 315/294

(57) ABSTRACT

In a light source inverter rectifier circuits are respectively connected to a CCFL in a substantially U-shaped lamp and a CCFL in a substantially U-shaped lamp, and the outputs from the rectifier circuits are fed to a stabilization circuit. Thus, the stabilization circuit monitors an average of currents flowing through the substantially U-shaped lamps. This makes it possible to make uniform the currents flowing through the substantially U-shaped lamps.

### BACKGROUND OF THE INVENTION

1. Field of the Invention

The present invention relates to an inverter for a light source device (hereinafter, “light source inverter”) that drives a cold cathode fluorescent lamp (CCFL) serving as a light source, and more particularly to a light source inverter that drives a light source in which two CCFLs are arranged substantially in the shape of the letter U. The present invention also relates to a light source device including such a light source inverter and CCFL, and to a display device and a liquid crystal display device including such a light source device.

2. Description of the Related Art

Since display devices such as television sets and monitors are required to be compact today, and even small-sized electrical devices such as mobile telephones and PDAs (personal digital assistants) are provided with display devices, thin display devices such as liquid crystal display devices are desired. Liquid crystal display devices are provided with a liquid crystal panel containing liquid crystal in which the orientation of its molecules can be changed by the application of a voltage. Light is modulated by employing variations in optical characteristics such as optical rotary power corresponding to the change in the molecular orientation of the liquid crystal in the liquid crystal panel. Thus, light corresponding in intensity to the brightness of each pixel is transmitted to allow a display operation; the liquid crystal panel in itself, however, emits no light. For this reason, a light source is required that illuminates the liquid crystal panel. Hence, two types of liquid crystal display devices are available: transmissive liquid crystal display devices, where a backlight is employed as a light source; and reflective liquid crystal display devices, where an outside light source is employed.

Since transmissive liquid crystal display devices have higher color saturation than reflective liquid crystal display devices, and thus provide easy-to-view images even in poorly-lit indoor conditions, they are becoming increasingly used. Disadvantageously, however, transmissive liquid crystal display devices consume a large amount of electric power, and their displayed images are not sufficiently bright in well-lit outdoor conditions. For this reason, semi-transmissive liquid crystal display devices become available today in which a backlight is employed in a poorly-lit area, whereas outside light is employed in a well-lit area. There are two types of transmissive liquid crystal display devices: direct-type transmissive liquid crystal display devices incorporating a backlight in which a plurality of CCFLs are disposed immediately behind a liquid crystal panel; and edge-light type transmissive liquid crystal display devices incorporating a backlight that passes the light emitted from CCFLs disposed at the edge of the device via the flat surface of a light guide plate.

In transmissive liquid crystal display devices incorporating such backlights, a substantially U-shaped lamp composed of two CCFLs arranged side by side is used as a light source for the backlights. The CCFLs are driven so that the substantially U-shaped lamp emits light. Since an alternating-current power supply is required for driving the CCFLs, the transmissive liquid crystal display device incorporating the backlight is provided with a light source inverter for generating an alternating-current voltage.

As an example of the configuration of a light source inverter, a light source device that includes two substantially U-shaped lamps, each having two CCFLs is shown in FIG. 10. The light source inverter shown in FIG. 10 includes: transformers 102a and 102b stepping up alternating-current voltages to apply these stepped-up voltages to CCFLs 101a and 101b, respectively, in a substantially U-shaped lamp 101x; transformers 102c and 102d stepping up alternating-current voltages to apply these stepped-up voltages to CCFLs 101c and 101d, respectively, in a substantially U-shaped lamp 101y; rectifier circuits 103a and 103b connected to the secondary sides of the transformers 102a and 102b, respectively, to perform half-wave rectification; a stabilization circuit 104 receiving the currents that are half-wave rectified by the rectifier circuits 103a and 103b; a switching circuit 105a connected to the primary sides of the transformers 102a and 102b to perform power control on the primary sides of the transformers 102a and 102b; a switching circuit 105b connected to the primary sides of the transformers 102c and 102d to perform power control on the primary sides of the transformers 102c and 102d; and a control circuit 106 that sets switching frequencies for the switching circuits 105a and 105b according to an output from the stabilization circuit 104.

In the light source inverter of the configuration shown in FIG. 10, the currents received from the rectifier circuits 103a and 103b connected to the low-voltage sides of the transformers 102a and 102b connected to the substantially U-shaped lamp 101x are smoothed and compared with the reference value by the stabilization circuit 104. Based on this comparison result, the control circuit 106 operates the switching circuits 105a and 105b so as to stabilize the voltages outputted from the secondary sides of the transformers 102a to 102d connected to the substantially U-shaped lamps 101x and 101y. In other words, the switching circuits 105a and 105b each perform feedback operations based on the currents that are fed from the transformers 102a and 102b and are then monitored by the stabilization circuit 104.

In the configuration shown in FIG. 10, however, when the CCFLs 101a to 101d in the substantially U-shaped lamps 101x and 101y vary in impedance, or when their impedances vary due to uneven thermal distribution within the backlight, there is a possibility that a required voltage is not supplied to the substantially U-shaped lamp 101y. Thus, variations in the impedance of the CCFLs 101a to 101d in the substantially U-shaped lamps 101x and 101y may cause variations in the brightness of the substantially U-shaped lamps 101x and 101y.

In particular, when a direct-type backlight is used in a liquid crystal display device having a large screen, a large number of substantially U-shaped lamps are arranged as shown in FIG. 11A. In this case, for example, when n substantially U-shaped lamps 101 are arranged, and the temperatures of the substantially U-shaped lamps 101 within a backlight decrease from the first row to the nth row as shown in FIG. 11B, the impedance of the substantially U-shaped lamp 101 in the first row more greatly differs from that of the substantially U-shaped lamp 101 in the nth row. Thus, for example, even if the rectifier circuits and the stabilization circuit are connected to the CCFLs 101a to 101b in the substantially U-shaped lamp 101 in the first row, and each of the voltages applied to the substantially U-shaped lamps 101 in the first to nth rows is attempted to be stabilized based on the current flowing through the substantially U-shaped lamp 101 in the first row, the currents flowing through the substantially U-shaped lamps 101 in the first to nth rows actually differ from each other.

In contrast, a backlight assembly is proposed in which a plurality of substantially U-shaped lamps are arranged, a stabilization circuit is connected to each of the substantially U-shaped lamps and feedback control is individually performed for each of the substantially U-shaped lamps (see patent document 1). When the configuration of the backlight assembly disclosed in patent document 1 is applied to that shown in FIG. 10, in the same manner that the rectifier circuits 103a and 103b and the stabilization circuit 104 are provided, two rectifier circuits connected to transformers 102c and 102d and the stabilization circuit that receives the half-wave rectified currents from the rectifier circuits are provided and a control circuit that controls the switching circuit 105b according to the output from the stabilization circuit is provided separately from the control circuit 106.

Like the backlight assembly in patent document 1, substantially U-shaped lamps, transformers and stabilization circuits are connected based on the connection relationship shown in FIG. 10. In this way, it is possible to eliminate differences between the currents generated when CCFLs are connected in parallel to one transformer and the complexity of interconnection caused by connecting a stabilization circuit to the CCFLs connected via a transformer in series. In the backlight assembly in patent document 1, a stabilization circuit is provided for each of substantially U-shaped lamps. Thus, unlike the case where the stabilization circuit is provided for only one substantially U-shaped lamp as shown in FIG. 10, since the backlight assembly in patent document 1 is provided with the stabilization circuit for each of the substantially U-shaped lamps, it is possible to control substantially U-shaped lamps individually, and also to eliminate differences between the currents flowing through the substantially U-shaped lamps.

Patent document 1: JP-A-2002-231034

### SUMMARY OF THE INVENTION

In a case where a stabilization circuit is provided for each of substantially U-shaped lamps as in the backlight assembly disclosed in patent document 1, however, when a large number of substantially U-shaped lamps are provided as in the case of FIG. 11A, it is necessary to provide stabilization circuits according to the number of the substantially U-shaped lamps. Thus, in this case, the size of the device is increased as compared with the case where the stabilization circuit is provided for only one substantially U-shaped lamp as shown in FIG. 10. On the other hand, since devices are required to be compact today, it is preferable that the size of the device be reduced by the use of one stabilization circuit. As described above, however, when a plurality of substantially U-shaped lamps are incorporated as in the case of FIG. 11A, the currents flowing through the substantially U-shaped lamps greatly differ from each other. This results in large variations in brightness, thus affecting unevenness in the display of a liquid crystal display device.

An object of the present invention is to provide a light source inverter and a light source device incorporating such a light source inverter that makes uniform currents flowing through individual substantially U-shaped lamps with a stabilization circuit that receives currents from lamps in different substantially U-shaped lamps. Another object of the present invention is to provide a display device and a liquid crystal display device, each incorporating a light source device that makes uniform currents flowing through individual substantially U-shaped lamps.

To achieve the above objects, according to one aspect of the present invention, a light source inverter includes: a plurality of transformers applying alternating-current voltages to a plurality of light-emitting lamps, respectively; a control section controlling electric power induced at secondary sides of the plurality of transformers; and a current detection section detecting currents flowing through two lamps, located apart from each other, of the plurality of transformers. Here, the control section controls the electric power induced at the secondary sides of the plurality of transformers based on the currents detected by the current detection section.

According to another aspect of the invention, a light source device is characterized in that it is provided with the light source inverter and a plurality of lamps driven by the light source inverter to emit light. Here, a direct-type backlight may be incorporated in which a plurality of lamps are arranged perpendicular to a direction where light is emitted; an edge-light type backlight may be incorporated that includes a light guide plate that directs light emitted from a plurality of lamps in a predetermined direction. In the edge-light type backlight, the lamps may be arranged on both sides of the light guide plate or the lamps may be arranged on one side of the light guide plate.

According to still another aspect of the invention, a display device is characterized in that it is provided with the light source device and a display section achieving display by receiving light from the light source device.

According to yet another aspect of the invention, a liquid crystal display device is characterized in that it is provided with the light source device serving as a backlight and a liquid crystal panel achieving display by receiving, from behind, light from the light source device, varying orientation of liquid crystal and thus changing a light transmittance of liquid crystal.

According to the present invention, it is possible to reduce variations in current due to variations in impedance by controlling the power supplied to the secondary sides of transformers based on currents following through two lamps located apart from each other. Thus, it is possible to make uniform the brightness of light emitted from each lamp serving as a light source. This helps reduce unevenness of light emitted from the light source device. Since transformers are all controlled by the detection of currents flowing through the two lamps, it is possible to reduce the size of a device as compared with the case where each transformer is individually controlled by the detection of currents flowing through all the lamps.

Other features, elements, processes, steps, characteristics and advantages of the present invention will become more apparent from the following detailed description of preferred embodiments of the present invention with reference to the attached drawings.

### BRIEF DESCRIPTION OF DRAWINGS

FIG. 1 is a block diagram showing the configuration of a light source device according to an embodiment of the present invention;

FIGS. 2A to 2E are timing charts showing the relationship between the input and output of rectifier circuits and the input of a stabilization circuit in the light source device shown in FIG. 1;

FIG. 3 is a block diagram showing one example of the configuration of the light source device and stabilization circuit shown in FIG. 1;

FIG. 4 is a cross-sectional view showing the configuration of an edge-light type transmissive liquid crystal display device employing the light source device of FIG. 1 as a backlight;

FIG. 5 is a block diagram showing the configuration of a light source device including n substantially U-shaped lamps;

FIG. 6A is a cross-sectional view showing the configuration of an edge-light type transmissive liquid crystal display device employing the light source of FIG. 5 as a backlight;

FIG. 6B is a cross-sectional view showing the configuration of an edge-light type transmissive liquid crystal display device employing the light source of FIG. 5 as a backlight;

FIG. 6C is a cross-sectional view showing the configuration of an edge-light type transmissive liquid crystal display device employing the light source of FIG. 5 as a backlight;

FIG. 7 is a cross-sectional view showing the configuration of a direct-type transmissive liquid crystal display device employing the light source of FIG. 5 as a backlight;

FIG. 8 is a block diagram showing an example of another configuration of the light source device according to the embodiment of the present invention;

FIG. 9A is a block diagram showing an example of another configuration of substantially U-shaped lamps used in the light source device according to the embodiment of the invention;

FIG. 9B is a block diagram showing an example of another configuration of substantially U-shaped lamps used in the light source device according to the embodiment of the invention;

FIG. 10 is a block diagram showing the configuration of a conventional light source inverter;

FIG. 11A is a diagram showing an example of how a plurality of substantially U-shaped lamps are arranged; and

FIG. 11B is a diagram showing thermal distribution in the substantially U-shaped lamps shown in FIG. 11A.

### DETAILED DESCRIPTION OF THE PREFERRED EMBODIMENTS

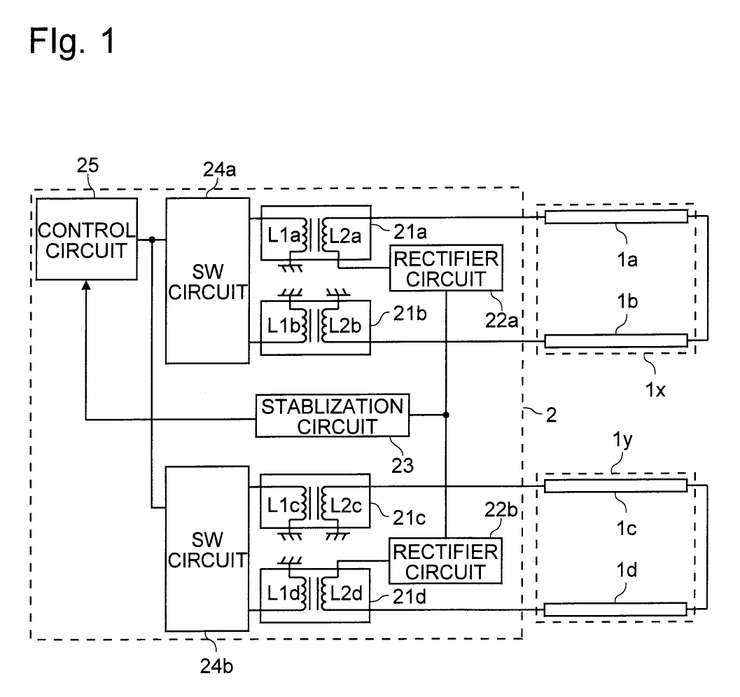

An embodiment of the present invention will be described with reference to the accompanying drawings. FIG. 1 is a block diagram schematically showing the configuration of a light source device serving as the backlight of this embodiment. FIG. 1 shows the light source device including two substantially U-shaped lamps.

The light source device shown in FIG. 1 is provided with two substantially U-shaped lamps 1x and 1y, and a light source inverter 2 for applying alternating-current voltages to the substantially U-shaped lamps 1x and 1y. The substantially U-shaped lamp 1x is composed of two CCFLs 1a and 1b connected in series; the substantially U-shaped lamp 1y is composed of two CCFLs 1c and 1d connected in series

The light source inverter 2 includes: transformers 21a to 21d producing alternating-current voltages that are applied to the CCFLs 1a to 1d, respectively; rectifier circuits 22a and 22b connected to the secondary sides of the transformers 21a and 21d; a stabilization circuit 23 receiving a voltage signal obtained by combining voltage signals that are half-wave rectified by the rectifier circuits 22a and 22b; a switching circuit 24a connected to the primary sides of the transformers 21a and 21b to perform power control on the primary sides of the transformers 21a and 21b; a switching circuit 24b connected to the primary sides of the transformers 21a and 21b to perform power control on the primary sides of the transformers 21a and 21b; and a control circuit 25 controlling the switching operations of the switching circuits 24a and 24b according to the output from the stabilization circuit 23.

In the light source inverter 2, one ends of primary coils L1a and L1b in the transformers 21a and 21b are connected to the switching circuit 24a; one ends of primary coils L1c and L1d in the transformers 21c and 21d are connected to the switching circuit 24b. The other ends of these primary coils L1a to L1d are grounded. One end of the CCFL 1a is connected to one end of the secondary coil L2a in the transformer 21a, and the rectifier circuit 22a is connected to the other end of the secondary coil L2a; one end of the CCFL 1b is connected to one end of the secondary coil L2b in the transformer 21b, and the other end of the secondary coil L2b is grounded. One end of the CCFL 1d is connected to one end of the secondary coil L2d in the transformer 21d, and the rectifier circuit 22b is connected to the other end of the secondary coil L2d; one end of the CCFL 1c is connected to one end of the secondary coil L2c in the transformer 21c, and the other end of the secondary coil L2c is grounded.

The other ends of the CCFLs 1a and 1b are connected together, and thus the secondary coil L2b, the CCFL 1b, the CCFL 1a, the secondary coil L2a and the rectifier circuit 22a are connected in series in turn from the ground side, on the secondary sides of the transformers 21a and 21b. The other ends of the CCFLs 1c and 1d are connected together, and thus the secondary coil L2c, the CCFL 1c, the CCFL 1d, the secondary coil L2d and the rectifier circuit 22b are connected in series in turn from the ground side, on the secondary sides of the transformers 21c and 21d. The CCFLs 1a and 1d are so arranged as to interpose the CCFLs 1b and 1c therebetween.

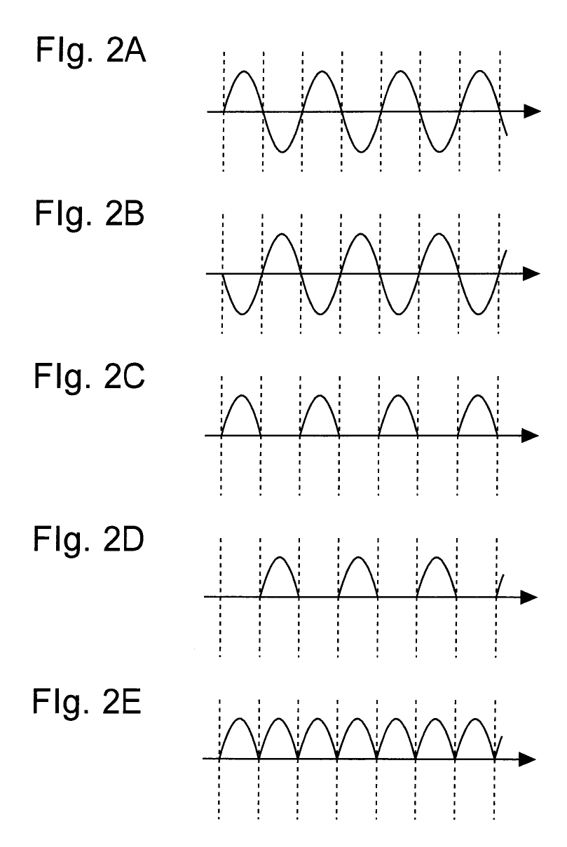

The operation of the light source device configured as described above will be described below. FIGS. 2A to 2E are timing charts showing the relationship between the input and output of the rectifier circuits 22a and 22b and the input of the stabilization circuit 23 in the light source device shown in FIG. 1.

The switching circuit 24a performs the switching operation under the control of the control circuit 25, and thus a desired alternating-current voltage appears across each of the secondary coils L2a and L2b in the transformers 21a and 21b. Here, the opposite-phase alternating-current voltage appears across each of the secondary coils L2a and L2b to allow the CCFLs 1a and 1b to emit light. Then, the alternating current as shown in FIG. 2A is passed through the rectifier circuit 22a. Similarly, the switching circuit 24b performs the switching operation under the control of the control circuit 25, and thus a desired alternating-current voltage appears across each of the secondary coils L2c and L2d in the transformers 21c and 21d. Here, the opposite-phase alternating-current voltage appears across each of the secondary coils L2c and L2d to allow the CCFLs 1c and 1d to emit light. Then, the alternating current as shown in FIG. 2B, which is in opposite phase with the input of the rectifier circuit 22a, is passed through the rectifier circuit 22b.

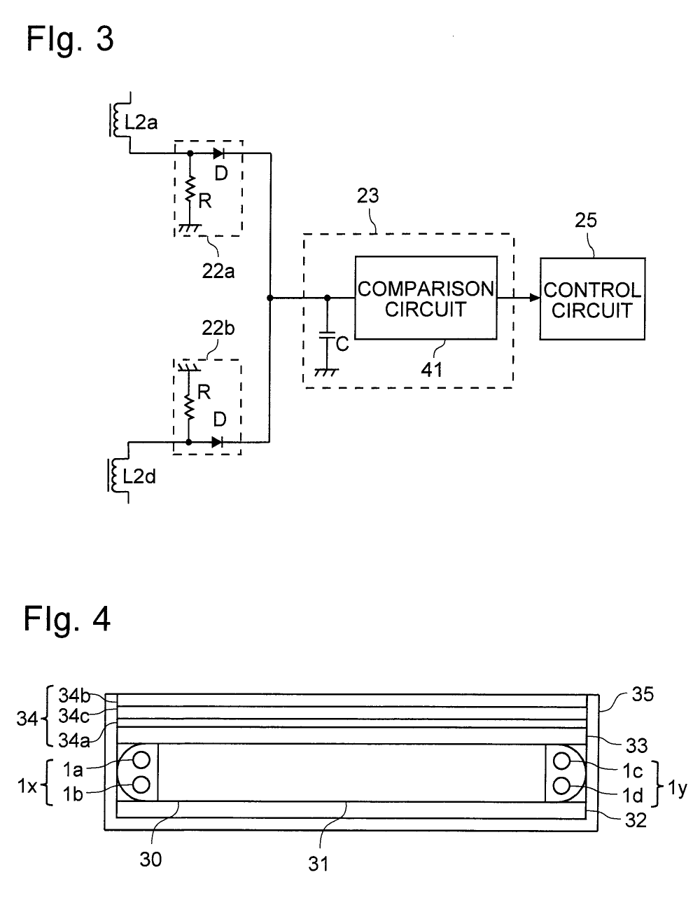

For example, as shown in FIG. 3, the rectifier circuit 22a (22b) includes: a resistor R having one end thereof connected to the other end of the secondary coil L2a (L2d) and the other end thereof grounded; and a diode D having the anode thereof connected to the node between the secondary coil L2a (L2d) and the resistor R. Thus, the rectifier circuit 22a (22b) operates as a half-wave rectifier circuit. Specifically, the alternating-current voltage corresponding to the resistance of the resistor R appears based on the alternating current inputted. The diode D allows the only positive component of the alternating-current voltage appearing across the resistor R to pass therethrough. In this way, the half-wave rectification is performed. Although the configuration of the rectifier circuit 22a is described by way of example, the rectifier circuit 22b is configured in the same way as the rectifier circuit 22a, as indicated by the parenthesized reference numerals following the corresponding reference numerals.

The alternating currents as shown in FIGS. 2A and 2B are half-wave rectified by the rectifier circuits 22a and 22b after voltage transformation. Thus, the rectifier circuit 22a outputs, as shown in FIG. 2C, a voltage signal having the positive component of the waveform shown in FIG. 2A. The rectifier circuit 22b outputs, as shown in FIG. 2D, a voltage signal having the positive component of the waveform shown in FIG. 2B; this voltage signal is 180 degrees out of phase with that from the rectifier circuit 22a shown in FIG. 2C.

The voltage signals outputted from these rectifier circuits 22a and 22b are fed to the stabilization circuit 23 as one input signal. Thus, the voltage signal fed to the stabilization circuit 23 is a voltage signal that is obtained by combining the voltage signals, as shown in FIGS. 2C and 2D, from the rectifier circuits 22a and 22b, that is, a voltage signal, as shown in FIG. 2E, that is full-wave rectified. Specifically, the voltage signals from the rectifier circuits 22a and 22b are 180 degrees out of phase with each other, and thus voltage signals from the rectifier circuits 22a and 22b become zero alternately. Hence, the positive components of the voltage signals are fed to the stabilization circuit 23. In other words, the full-wave rectified voltage signal as shown in FIG. 2E is fed to the stabilization circuit 23.

For example, as shown in FIG. 3, the stabilization circuit 23 is provided with: a smoothing circuit including a capacitor C that has one end thereof connected to the cathodes of the diodes D serving as output terminals of the rectifier circuits 22a and 22b and the other end thereof grounded; and a comparison circuit 41 that compares, with a reference voltage, the voltage appearing across the capacitor C of the smoothing circuit, and that feeds the comparison result to the control circuit 25. The stabilization circuit 23 shown in FIG. 3 smoothes, with the capacitor C in the smoothing circuit, the full-wave rectified voltage signal as shown in FIG. 2E which is obtained by combining the voltage signals, as shown in FIGS. 2C and 2D, from the rectifier circuits 22a and 22b. This smoothed voltage signal is fed to the comparison circuit 41, which compares this voltage signal with the reference voltage to feed the comparison result to the control signal 25.

The control circuit 25 controls the switching operations of the switching circuits 24a and 24b according to the comparison result of the comparison circuit 41 included in the stabilization circuit 23. As described above, the control signal fed to the control circuit 25 is a signal that is based on the voltage obtained by smoothing the voltage signal corresponding to the currents (that is, the currents flowing through the CCFLs 1a and 1d) flowing through the secondary coils L2a and L2d in the transformers 2a and 2d. Specifically, the stabilization circuit 23 smoothes the full-wave rectified signal obtained by combing the signals that are generated by the half-wave rectification of the currents flowing through the CCFLs 1a and 1d. Consequently, the level of the voltage signal fed to the comparison circuit 41 corresponds to the average of the currents flowing through the CCFLs 1a and 1d.

With the light source device of the configuration of FIG. 1, the operation of the switching circuit 24a and 24b in the light source inverter 2 is controlled by the operation circuit 25 through the feedback of the average of the currents flowing through the CCFLs 1a and 1d. Thus, even if the impedances of the CCFLs 1a to 1d vary due to the uneven thermal distribution within the housing of the backlight in the light source, the currents that are substantially equal to those flowing through the CCFLs 1a and 1d can be applied irrespective of impedance variations. Thus, it is possible to reduce the influence of impedance variations, and to make more uniform the currents applied to the CCFLs 1a to 1d.

The liquid crystal display device incorporating the light source device shown in FIG. 1 as a backlight is configured as shown in the cross section of FIG. 4. A light guide plate 31 is disposed between the substantially U-shaped lamp 1x composed of the CCFLs 1a and 1b and the substantially U-shaped lamp 1y composed of the CCFLs 1c and 1d. In this way, the light from the substantially U-shaped lamps 1x and 1y arranged on the edges of the light guide plate 31 can be emitted from the surface of the light guide plate 31 in a direction perpendicular to the surface of the light guide plate 31. In this case, the CCFLs 1a and 1b in the substantially U-shaped lamp 1x are arranged side by side in a direction perpendicular to the surface of the light guide plate 31; the CCFLs 1c and 1d in the substantially U-shaped lamp 1y are arranged side by side in a direction perpendicular to the surface of the light guide plate 31.

On the back of the light guide plate 31 is disposed a reflective plate 32 that covers a backlight 30 composed of the light guide plate 31 and the substantially U-shaped lamps 1x and 1y. On the front of the light guide plate 31, a plurality of optical sheets 33 are first disposed to cover the backlight 30 so as to make uniform the brightness of the light from the backlight 30, and a liquid crystal display panel 34 is then disposed so as to cover the surface of the optical sheets 33. The reflective plate 32, the backlight 30, the optical sheets 33 and the liquid crystal display panel 34 stacked as described above are covered by a housing 35. In this way, the liquid crystal display device is formed. The backlight 30 includes the light guide plate 31; the liquid crystal display device shown in FIG. 4 serves as an edge-light type transmissive liquid crystal display device.

The liquid crystal display panel 34 includes: a thin-film transistor substrate 34a in which thin-film transistors are formed in a matrix on a glass substrate by the deposition of transparent semiconductor films such as an ITO (indium tin oxide) film; a color filter substrate 34b composed of a plurality of different color filters, such as red, green and blue color filters, which are formed and arranged on the surface of the thin-film transistor substrate 34a for the individual pixels; and liquid crystal 34c injected between the thin-film transistor substrate 34a and the color filter substrate 34b.

In the liquid crystal display panel 34 configured as described above, the light from the light guide plate 31 in the backlight 30 and the reflective plate 32 enters the thin-film transistor substrate 34a. Here, electric power is supplied to the source and gate terminals of the thin-film transistors for the individual pixels in the thin-film transistor substrate 34a, and this allows electric fields to be generated between the thin-film transistors in the thin-film transistor substrate 34a and the color filters in the color filter substrate 34b. This electric field causes a change in the angle of orientation of the liquid crystal molecules in each pixel, thereby varying the transmittance of the liquid crystal 34c in each pixel. In this way, the light having a predetermined brightness level for each pixel is passed through the liquid crystal 34c and the color filter substrate 34b, with the result that color images are displayed on the liquid crystal display panel 34.

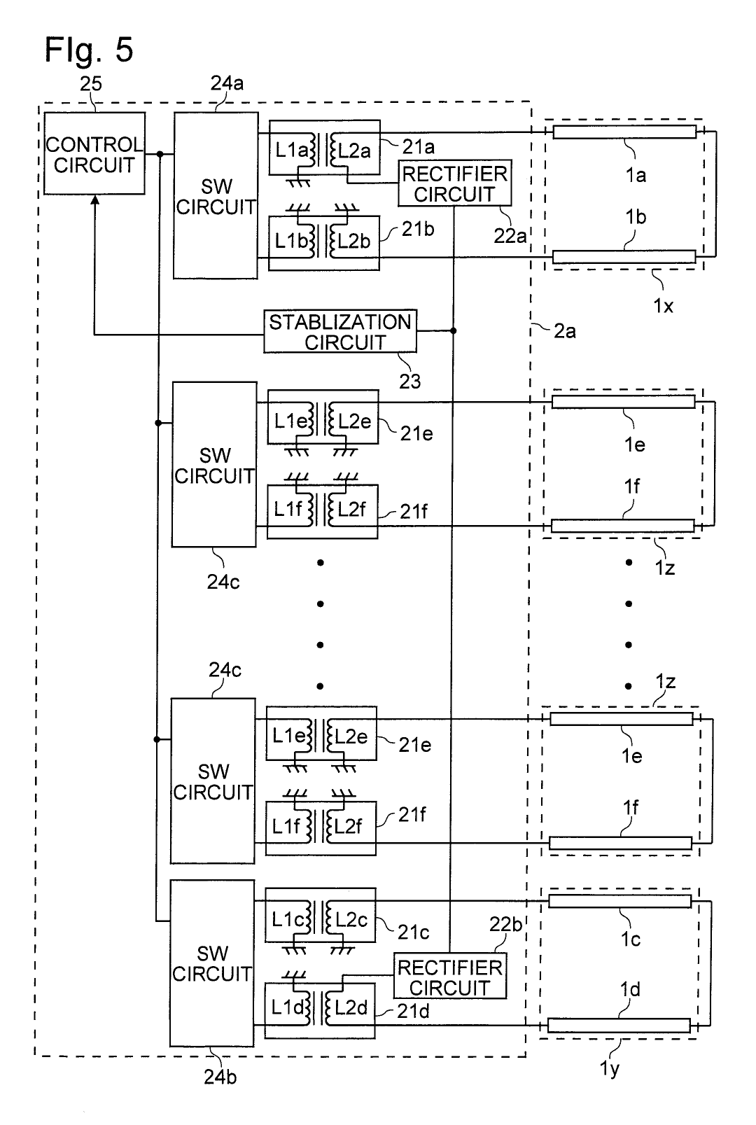

Although the light source device configured as shown in FIG. 1 incorporates two substantially U-shaped lamps 1x and 1y, three or more substantially U-shaped lamps may be incorporated to practice the present invention. FIG. 5 is a block diagram showing the configuration of a light source device incorporating n substantially U-shaped lamps. In the light source device shown in FIG. 5, such parts as are used for the same purposes as those in the light source device shown in FIG. 1 are identified with common reference numerals, and the detailed description thereof will not be repeated.

The light source device shown in FIG. 5 is provided with: the two substantially U-shaped lamps 1x and 1y included in the light source device shown in FIG. 1; and (n−2) substantially U-shaped lamps 1z. In stead of the light source inverter 2, the light source device shown in FIG. 5 is provided with a light source inverter 2a that includes, along with the transformers 21a to 21d, 2×(n−2) transformers 21e and 21f connected to 2×(n−2) CCFLs 1e and 1f, respectively, in the (n−2) substantially U-shaped lamps 1z.

In addition to the switching circuit 24a controlling the switching of the transformers 21a and 21b and the switching circuit 24b controlling the switching of the transformers 21c and 21d, the light source inverter 2a is provided with: (n−2) switching circuits 24c respectively controlling the switching of the (n−2) pairs of the transformers 21e and 21f for the (n−2) substantially U-shaped lamps 1z; the rectifier circuits 22a and 22b; the stabilization circuit 23; and the control circuit 25. The controls circuit 25 controls the switching of the n switching circuits 24a to 24c according to the control signal outputted from the stabilization circuit 23.

The primary coils L1e and L1f in the transformers 21e and 21f have one ends thereof grounded and the other ends thereof connected to the switching circuit 24c. The secondary coil L2e in the transformer 21e has one end thereof grounded and the other end thereof connected to one end of the CCFL 1e in the substantially U-shaped lamp 1z. The secondary coil L2f in the transformer 21f has one end thereof grounded and the other end thereof connected to one end of the CCFL 1f in the substantially U-shaped lamp 1z. In the substantially U-shaped lamps 1z, the other ends of the CCFLs 1e and 1f are connected together. Thus, on the secondary sides of the transformers 21e and 21f, the series circuit composed of the secondary coil L2e and the CCFL 1e is connected in parallel with the series circuit composed of the secondary coil L2f and the CCFL 1f. The configuration other than the transformers 21e and 21f and the substantially U-shaped lamps 1z is the same as that in FIG. 1.

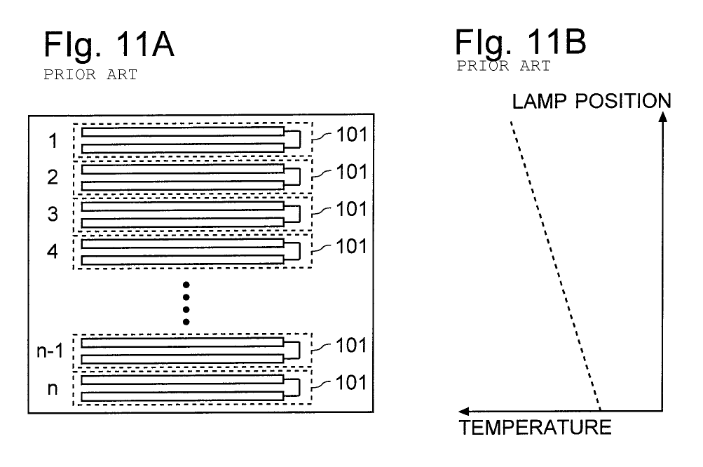

The substantially U-shaped lamps 1z are disposed between the substantially U-shaped lamps 1x and 1y. The CCFL 1a in the substantially U-shaped lamp 1x and the CCFL 1d in the substantially U-shaped lamp 1y are disposed at either side of the light source device; the CCFLs 1a and 1d are so arranged as to interpose the CCFLs 1b, 1c, 1e and 1f therebetween. As shown in FIG. 5, the CCFLs 1a to 1f are arranged in the order of 1a, 1b, 1e, 1f, 1e, 1f, . . . 1e, 1f, 1c and 1d. Hence, when heat is distributed within the light source device as shown in FIG. 11B, the CCFL 1a disposed in the area where the temperature is the highest and the CCFL 1d disposed in the area where the temperature is the lowest are connected to the rectifier circuits 22a and 22b, respectively.

Hence, the average of the currents through the CCFLs 1a and 1d, whose impedances are most different from each other, are monitored by the stabilization circuit 23; the control circuit 25 controls the switching operations of the switching circuits 24a to 24c according to the average of the currents through the CCFLs 1a and 1d. Thus, since the currents flowing through (2×n) CCFLs 1a to 1f are controlled to be substantially equal to each other, the amounts of light emitted from the n substantially U-shaped lamps 1x to 1z are substantially equal to each other.

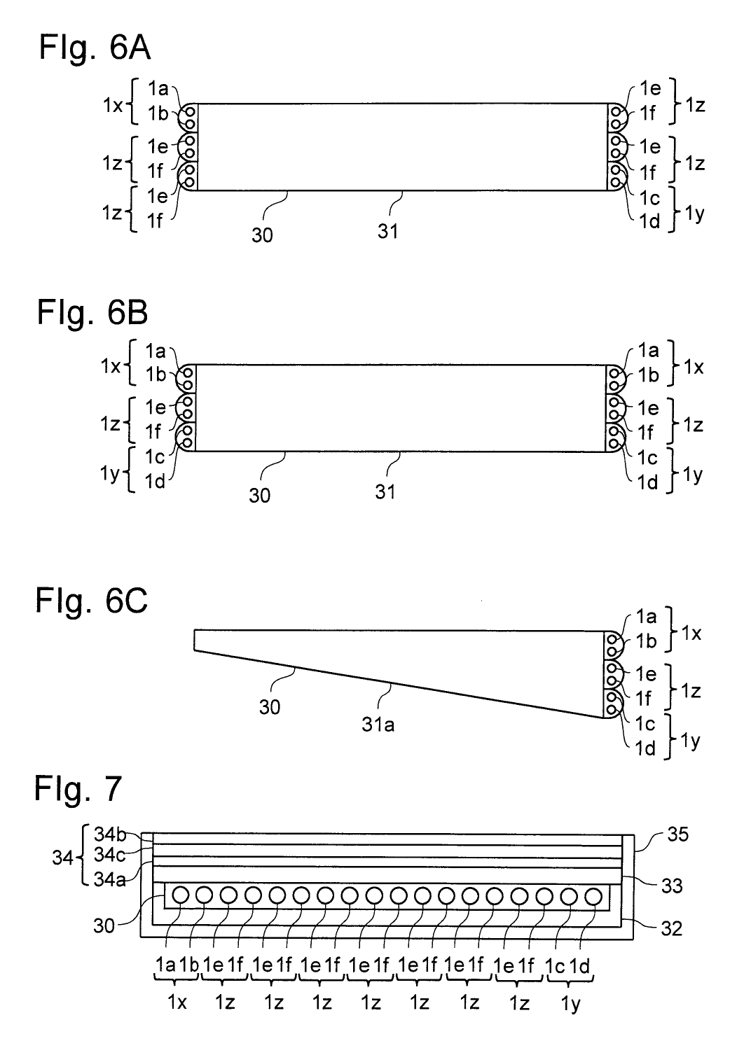

When the light source device including the n substantially U-shaped lamps 1x to 1z is used as a backlight, the substantially U-shaped lamps 1x and 1z, as shown in FIG. 6A, may be arranged on one side of the light guide plate 31 and the substantially U-shaped lamps 1y and 1z may be arranged on the other side of the light guide plate 31 in the same manner that the backlight shown in FIG. 4 is configured. The substantially U-shaped lamps 1x to 1z configured as shown in the block diagram of FIG. 5 may be arranged, as shown in FIG. 6B, on each side of the light guide plate 31. The substantially U-shaped lamps configured as shown in the block diagram of FIG. 1 may be arranged on each side of the light guide plate shown in FIG. 6B.

Although the edge-light type transmissive liquid crystal display devices described above incorporate the backlight that has the substantially U-shaped lamps on both sides of the light guide plate, the substantially U-shaped lamps 1x to 1z serving as a light source may be arranged, as shown in FIG. 6C, on one end face of a wedge-shaped light guide plate 31a. The thickness of the wedge-shaped light guide plate 31a in the direction perpendicular to the surface of the light guide plate 31a decreases as the light guide plate 31a extends away from the end face on which the substantially U-shaped lamps 1x to 1z are arranged. The substantially U-shaped lamps 1x to 1z are arranged side by side in a direction perpendicular to the surface of the light guide plate 31a. Although the light source devices shown in FIGS. 6A to 6C and configured as shown in the block diagram of FIG. 5 are described by way of example, the wedge-shaped light guide plate 31a that has the substantially U-shaped lamps 1x and 1y serving as a light source on one end face of the light guide plate 31a may be likewise used in the light source device configured as shown in the block diagram of FIG. 1.

In stead of the edge-light transmissive liquid crystal display device, a direct-type transmissive liquid crystal display device may be used that has a plurality of substantially U-shaped lamps below the optical sheets. When the light source device configured as shown in the block diagram of FIG. 5 is used as a backlight for the direct-type transmissive liquid crystal display device, a plurality of substantially U-shaped lamps 1z are arranged, as shown in FIG. 7, between the substantially U-shaped lamps 1x and 1y. These substantially U-shaped lamps 1x to 1z are aligned on the surface of the light guide plate 32 covering the inside bottom of the housing 35 so as to emit light from the back of the liquid crystal display panel 34 through the optical sheets 33. The direct-type transmissive liquid crystal display device may incorporate, as a backlight, the light source device configured as shown in the block diagram of FIG. 1.

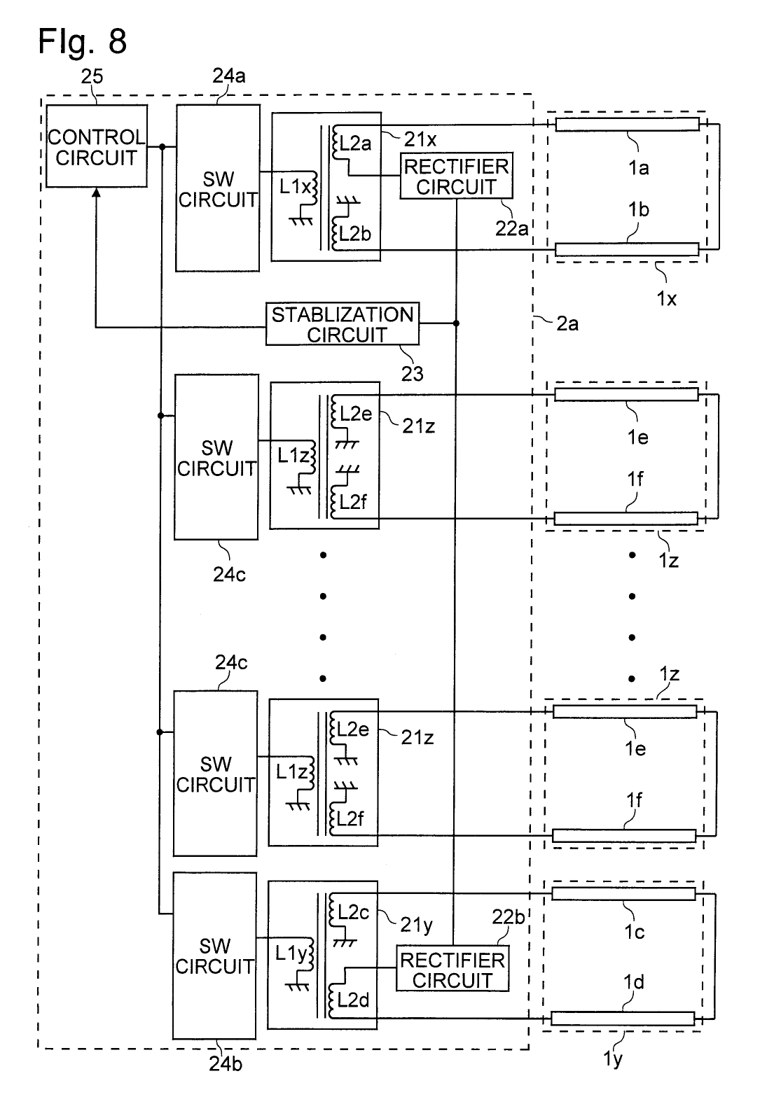

Although in this embodiment, each transformer has one primary coil and one secondary coil as shown in FIGS. 1 and 5, each transformer may have one primary coil and two secondary coils as shown in FIG. 8. That is, in the block diagrams shown in FIGS. 1 and 5, a primary coil is provided for the secondary coil connected to each CCFL, and a transformer having one primary coil and one secondary coil is provided for each of CCFLs.

In the case of FIG. 8, there are provided: a primary coil L1x engaged in electromagnetic induction with the secondary coils L2a and L2b connected to the CCFLs 1a and 1b; a primary coil L1y engaged in electromagnetic induction with the secondary coils L2c and L2d connected to the CCFLs 1c and 1d; and primary coils L1z engaged in electromagnetic induction with the secondary coils L2e and L2f connected to the CCFLs 1e and 1f.

That is, in the configuration of FIG. 8, instead of the transformers 21a to 21f shown in FIG. 5, there are provided: a transformer 21x having the primary coil L1x and the secondary coils L2a and L2b; a transformer 21y having the primary coil L1y and the secondary coils L2c and L2d; and transformers 21z having the primary coils L1z and the secondary coils L2e and L2f. With the configuration of FIG. 8 where each transformer has one primary coil and two secondary coils, it is possible to achieve the same effect as the case where one transformer is provided for each of the substantially U-shaped lamps.

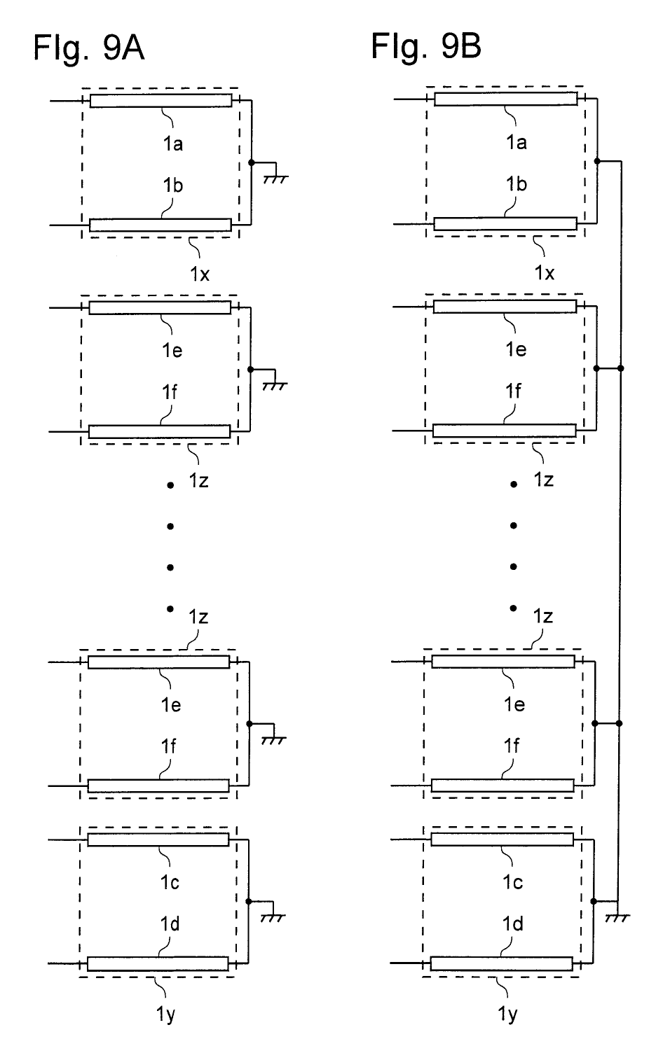

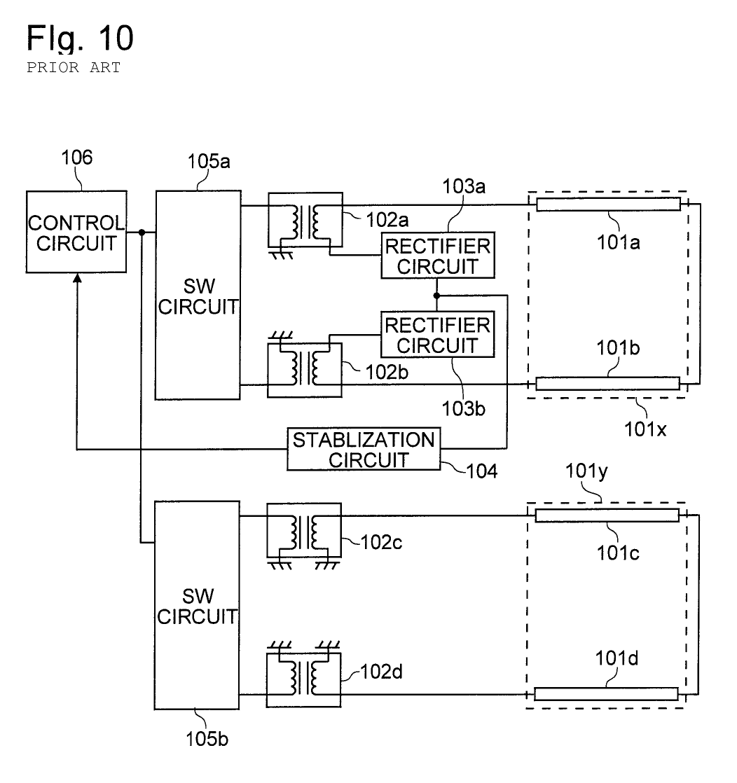

In the above-described substantially U-shaped lamps 1x to 1z, each composed of two CCFLs, the nodes between two CCFLs, that is, the midpoints of the substantially U-shaped lamps 1x to 1z may be individually grounded via separate lines as shown in FIG. 9A; the nodes between two CCFLs, that is, the midpoints of the substantially U-shaped lamps 1x to 1z may be grounded together via a common line as shown in FIG. 9B.

That is, in the case of FIG. 9A, the node between the CCFLs 1a and 1b in the substantially U-shaped lamp 1x, the node between the CCFLs 1c and 1d in the substantially U-shaped lamp 1y and the nodes between the CCFLs 1e and 1f in the substantially U-shaped lamps Ix are grounded via the separate lines. In the case of FIG. 9B, the node between the CCFLs 1a and lb in the substantially U-shaped lamp 1x, the node between the CCFLs 1c and 1d in the substantially U-shaped lamp 1y and the nodes between the CCFLs 1e and 1f in the substantially U-shaped lamps 1x are grounded together via the common line.

The present invention can be applied to light source devices incorporating a plurality of lamps as a light source that illuminates displayed portions; such light source devices can be used as direct-type and edge-light type backlights. These backlights can be used as display devices for transmissive liquid crystal display devices and semi-transmissive liquid crystal display devices.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-10. (canceled)

11. A light source inverter comprising:
a plurality of transformers applying alternating-current voltages to a plurality of light-emitting lamps, respectively;
a control section controlling electric power induced at secondary sides of the plurality of transformers; and
a current detection section detecting currents flowing through two lamps, located apart from each other, of the plurality of transformers,
wherein the control section controls the electric power induced at the secondary sides of the plurality of transformers based on the currents detected by the current detection section.

12. The light source inverter of claim 11,
wherein the current detection section comprises:
a first half-wave rectifier circuit detecting and half-wave rectifying the current flowing through one of the two lamps;
a second half-wave rectifier circuit detecting and half-wave rectifying the current flowing through the other of the two lamps; and
a stabilization circuit combining signals from the first and second half-wave rectifier circuits to determine an average of the currents flowing through the two lamps, and
the control section operates based on an output from the stabilization circuit.

13. The light source inverter of claim 11,
wherein the lamps are each a substantially U-shaped lamp composed of two cathode fluorescent lamps, and the current detection section detects, in each of the two lamps, a current flowing through one of the two cathode fluorescent lamps.

14. The light source inverter of claim 13,
wherein the current detection section comprises:
a first half-wave rectifier circuit detecting and half-wave rectifying the current flowing through one of the two lamps;
a second half-wave rectifier circuit detecting and half-wave rectifying the current flowing through the other of the two lamps; and
a stabilization circuit combining signals from the first and second half-wave rectifier circuits to determine an average of the currents flowing through the two lamps, and
the control section operates based on an output from the stabilization circuit.

15. A light source device comprising:
the light source inverter of claim 11; and
a plurality of lamps driven by the light source inverter to emit light.

16. The light source device of claim 15, further comprising:
a light guide plate directing the light emitted from the plurality of lamps in a predetermined direction.

17. A display device comprising:
the light source device of claim 15; and
a display section achieving display by receiving light from the light source device.

18. A display device comprising:
the light source device of claim 16; and
a display section achieving display by receiving light from the light source device.

19. A liquid crystal display panel comprising:
the light source device of claim 15 serving as a backlight; and
a liquid crystal panel achieving display by receiving, from behind, light from the light source device, varying orientation of liquid crystal and thus changing a light transmittance of liquid crystal.

20. A liquid crystal display panel comprising:
the light source device of claim 16 serving as a backlight; and
a liquid crystal panel achieving display by receiving, from behind, light from the light source device, varying orientation of liquid crystal and thus changing a light transmittance of liquid crystal.
